(19) United States
(12) Patent Application Publication
(10) Pub. No.: US 2018/0089959 A1
(43) Pub. Date: Mar. 29, 2018

(54) NETWORK GAME SYSTEM AND METHOD

(71) Applicant: Chong Son NA, Garland, TX (US)

(72) Inventor: Chong Son NA, Garland, TX (US)

(21) Appl. No.: 15/720,370

(22) Filed: Sep. 29, 2017

Related U.S. Application Data
(63) Continuation-in-part of application No. 15/303,350, filed on Oct. 11, 2016, now abandoned.
(60) Provisional application No. 61/981,406, filed on Apr. 18, 2014.

(51) Int. Cl. G07F 17/32

(52) U.S. Cl. CPC G07F 17/3293; G07F 17/3244; G07F 17/3272; G07F 17/3211; G07F 17/3209

(57) ABSTRACT

A gaming system is provided. The gaming system displays a hand of three cards from a deck of cards to an operator of the gaming system. The deck of cards comprises at least three Gwang cards, at least nine ribbon cards, and at least eight animal cards. Three community cards are displayed face down. Three rounds of betting are received with one face-down community card being flipped between each round of betting. A winning hand is determined based on a rank of the three cards in the hand and the three community cards as compared to three cards assigned to another computing system.

### CROSS-REFERENCE TO RELATED APPLICATION

This application is the continuation-in-part of U.S. application Ser. No. 15/303,350 which is the national stage entry of International Patent Application No. PCT/US2015/026527 filed Apr. 17, 2015, which claims benefit of U.S. provisional application Ser. No. 61/981,406 filed Apr. 18, 2014, which are hereby incorporated herein by reference in its entirety.

### FIELD

The subject matter herein generally relates to a game. Particularly, the subject matter herein generally relates to a game that can be played on a network, by a computer, or by individuals.

### BACKGROUND

In the era of information and multimedia, computers have been widely distributed to homes and offices and their use is increasing rapidly. People are able to enjoy different types of online games on the web, as the worldwide internet network rapidly expands.

Generally, typical computer games are categorized into genres such as role playing games, strategic simulation games, action shooting games, board games, trivia games, puzzle games, etc. They are also categorized as two-dimensional or three-dimensional games according to their graphic expression format. In addition to single-play games, network games are very popular and allow multiple players to play the same game simultaneously.

Go-Stop is a type of Hwatu card game. Go-Stop reflects the traditional culture of the East (especially Korea) and represents the seasonal customs in each month, monthly festivals, various holidays, customs, rituals, and even educational lessons.

A Hwatu deck consists of 48 cards in total with 12 different categories. The 48 cards are divided into four sets of 12 cards, which symbolize the 12 months of the year. Generally, pine represents January; plum blossom represents February; cherry blossom represents March; wisteria represents April; iris represents May; peony represents June; bush clover represents July; Susuki grass represents August; chrystanthemum represents September; maple represents October; willow represents November; and paulownia represents December.

Additionally, traditional Hwatu consists of 20-point (ggut) Gwang cards, 10-point (ggut) Animal cards (dongmul), 5-point (ggut) ribbon cards (tti), and 0-point (ggut) junk cards (pi). January, March, August, November, and December include the Gwang cards.

Different types of Hwatu games exist. In particular, Go-Stop is one of the most popular Hwatu games in Korea. Generally, three players play the game, but two or even more than four players can play the game. When a player scores three points or more, he or she wins a game. Go-Stop is called “Mat-Go” when there are two or less players. In Mat-Go, a player who scores more than seven points wins the game. When there are more than four players, if a player does not have desirable cards or wants to discard cards for any reason, the player can leave the game, and the number of players to play a single game is decreased correspondingly.

A Poker deck typically consists of 52 cards plus one to two joker cards. Each card has one of the four symbols consisting of spade, heart, diamond, and club. Each symbol consists of numbers between 2 and 10, and figures of A (Ace), K (King), Q (Queen), and J (Jack).

In Poker, there is a hierarchy of the cards based on numbers or figures. The spade is the highest figure, then diamond, heart, club, respectively. Also, the order in number descends from A to K, Q, J, 10, 9, 8, 7, 6, 5, 4, 3, 2. An ace can also be used as the lowest ranking card to result in a descending number order of K, Q, J, 10, 9, 8, 7, 6, 5, 4, 3, 2, and A.

Presently, Go-Stop or Poker games currently available on the internet or on personal cellular phones follow above traditional game rules or existing off-line game rules.

### BRIEF DESCRIPTION OF THE DRAWINGS

Implementations of the present technology will now be described, by way of example only, with reference to the attached figures, wherein:

FIG. 1 is a diagram of the composition of a deck of cards in accordance with certain embodiments of the present disclosure;

FIG. 2 is a diagram of a variation of a first ranking hand composition in accordance with certain embodiments of the present disclosure;

FIG. 3A is a diagram of a variation of a second ranking hand composition in accordance with certain embodiments of the present disclosure;

FIG. 3B is a diagram of a variation of a second ranking hand composition in accordance with certain embodiments of the present disclosure;

FIG. 3C is a diagram of a variation of a second ranking hand composition in accordance with certain embodiments of the present disclosure;

FIG. 4A is a diagram of a variation of a third ranking hand composition in accordance with certain embodiments of the present disclosure;

FIG. 4B is a diagram of a variation of a third ranking hand composition in accordance with certain embodiments of the present disclosure;

FIG. 4C is a diagram of a variation of a third ranking hand composition in accordance with certain embodiments of the present disclosure;

FIG. 5 is a diagram of a variation of a fourth ranking hand composition in accordance with certain embodiments of the present disclosure;

FIG. 6 is a diagram of a variation of a fifth ranking hand composition in accordance with certain embodiments of the present disclosure;

FIG. 7A is a diagram of a variation of a sixth ranking hand composition in accordance with certain embodiments of the present disclosure;

FIG. 7B is a diagram of a variation of a sixth ranking hand composition in accordance with certain embodiments of the present disclosure;

FIG. 7C is a diagram of a variation of a sixth ranking hand composition in accordance with certain embodiments of the present disclosure;

FIG. 8A is a diagram of a variation of a seventh ranking hand composition in accordance with certain embodiments of the present disclosure;

FIG. 8B is a diagram of a variation of a seventh ranking hand composition in accordance with certain embodiments of the present disclosure;

FIG. 8C is a diagram of a variation of a seventh ranking hand composition in accordance with certain embodiments of the present disclosure;

FIG. 9A is a diagram of a variation of an eighth ranking hand composition in accordance with certain embodiments of the present disclosure;

FIG. 9B is a diagram of a variation of an eighth ranking hand composition in accordance with certain embodiments of the present disclosure;

FIG. 9C is a diagram of a variation of an eighth ranking hand composition in accordance with certain embodiments of the present disclosure;

FIG. 10A is a diagram of a variation of a ninth ranking hand composition in accordance with certain embodiments of the present disclosure;

FIG. 10B is a diagram of a variation of a ninth ranking hand composition in accordance with certain embodiments of the present disclosure;

FIG. 10C is a diagram of a variation of a ninth ranking hand composition in accordance with certain embodiments of the present disclosure;

FIG. 10D is a diagram of a variation of a ninth ranking hand composition in accordance with certain embodiments of the present disclosure;

FIG. 11A is a diagram of a variation of a tenth ranking hand composition in accordance with certain embodiments of the present disclosure;

FIG. 11B is a diagram of a variation of a tenth ranking hand composition in accordance with certain embodiments of the present disclosure;

FIG. 11C is a diagram of a variation of a tenth ranking hand composition in accordance with certain embodiments of the present disclosure;

FIG. 12A is a diagram of a variation of a tenth ranking hand composition in accordance with certain embodiments of the present disclosure;

FIG. 12B is a diagram of a variation of a tenth ranking hand composition in accordance with certain embodiments of the present disclosure;

FIG. 12C is a diagram of a variation of a tenth ranking hand composition in accordance with certain embodiments of the present disclosure;

FIG. 13A is a diagram of a variation of a tenth ranking hand composition in accordance with an exemplary embodiment;

FIG. 13B is a diagram of a variation of a tenth ranking hand composition in accordance with certain embodiments of the present disclosure;

FIG. 13C is a diagram of a variation of a tenth ranking hand composition in accordance with certain embodiments of the present disclosure;

FIG. 14A is a diagram of a variation of a tenth ranking hand composition in accordance with certain embodiments of the present disclosure;

FIG. 14B is a diagram of a variation of a tenth ranking hand composition in accordance with certain embodiments of the present disclosure;

FIG. 14C is a diagram of a variation of a tenth ranking hand composition in accordance with certain embodiments of the present disclosure;

FIG. 15A is a diagram of a variation of a tenth ranking hand composition in accordance with certain embodiments of the present disclosure;

FIG. 15B is a diagram of a variation of a tenth ranking hand composition in accordance with certain embodiments of the present disclosure;

FIG. 15C is a diagram of a variation of a tenth ranking hand composition in accordance with certain embodiments of the present disclosure;

FIG. 16A is a diagram of a variation of a tenth ranking hand composition in accordance with certain embodiments of the present disclosure;

FIG. 16B is a diagram of a variation of a tenth ranking hand composition in accordance with certain embodiments of the present disclosure;

FIG. 16C is a diagram of a variation of a tenth ranking hand composition in accordance with certain embodiments of the present disclosure;

FIG. 17A is a diagram of a variation of a tenth ranking hand composition in accordance with certain embodiments of the present disclosure;

FIG. 17B is a diagram of a variation of a tenth ranking hand composition in accordance with certain embodiments of the present disclosure;

FIG. 17C is a diagram of a variation of a tenth ranking hand composition in accordance with certain embodiments of the present disclosure;

FIG. 18A is a diagram of a variation of a tenth ranking hand composition in accordance with certain embodiments of the present disclosure;

FIG. 18B is a diagram of a variation of a tenth ranking hand composition in accordance with certain embodiments of the present disclosure;

FIG. 18C is a diagram of a variation of a tenth ranking hand composition in accordance with certain embodiments of the present disclosure;

FIG. 19A is a diagram of a variation of a tenth ranking hand composition in accordance with certain embodiments of the present disclosure;

FIG. 19B is a diagram of a variation of a tenth ranking hand composition in accordance with certain embodiments of the present disclosure;

FIG. 19C is a diagram of a variation of a tenth ranking hand composition in accordance with certain embodiments of the present disclosure;

FIG. 20A is a diagram of a variation of an eleventh ranking hand composition in accordance with certain embodiments of the present disclosure;

FIG. 20B is a diagram of a variation of an eleventh ranking hand composition in accordance with certain embodiments of the present disclosure;

FIG. 20C is a diagram of a variation of an eleventh ranking hand composition in accordance with certain embodiments of the present disclosure;

FIG. 20D is a diagram of a variation of an eleventh ranking hand composition in accordance with certain embodiments of the present disclosure;

FIG. 21A is a diagram of a variation of an eleventh ranking hand composition in accordance with certain embodiments of the present disclosure;

FIG. 21B is a diagram of a variation of an eleventh ranking hand composition in accordance with certain embodiments of the present disclosure;

FIG. 21C is a diagram of a variation of an eleventh ranking hand composition in accordance with certain embodiments of the present disclosure;

FIG. 21D is a diagram of a variation of an eleventh ranking hand composition in accordance with certain embodiments of the present disclosure;

FIG. 22A is a diagram of a variation of an eleventh ranking hand composition in accordance with certain embodiments of the present disclosure;

FIG. 22B is a diagram of a variation of an eleventh ranking hand composition in accordance with certain embodiments of the present disclosure;

FIG. 22C is a diagram of a variation of an eleventh ranking hand composition in accordance with certain embodiments of the present disclosure;

FIG. 22D is a diagram of a variation of an eleventh ranking hand composition in accordance with certain embodiments of the present disclosure;

FIG. 23A is a diagram of a variation of an eleventh ranking hand composition in accordance with certain embodiments of the present disclosure;

FIG. 23B is a diagram of a variation of an eleventh ranking hand composition in accordance with certain embodiments of the present disclosure;

FIG. 23C is a diagram of a variation of an eleventh ranking hand composition in accordance with certain embodiments of the present disclosure;

FIG. 23D is a diagram of a variation of an eleventh ranking hand composition in accordance with certain embodiments of the present disclosure;

FIG. 24A is a diagram of a variation of an eleventh ranking hand composition in accordance with certain embodiments of the present disclosure;

FIG. 24B is a diagram of a variation of an eleventh ranking hand composition in accordance with certain embodiments of the present disclosure;

FIG. 24C is a diagram of a variation of an eleventh ranking hand composition in accordance with certain embodiments of the present disclosure;

FIG. 24D is a diagram of a variation of an eleventh ranking hand composition in accordance with certain embodiments of the present disclosure;

FIG. 25A is a diagram of a variation of an eleventh ranking hand composition in accordance with certain embodiments of the present disclosure;

FIG. 25B is a diagram of a variation of an eleventh ranking hand composition in accordance with certain embodiments of the present disclosure;

FIG. 25C is a diagram of a variation of an eleventh ranking hand composition in accordance with certain embodiments of the present disclosure;

FIG. 25D is a diagram of a variation of an eleventh ranking hand composition in accordance with certain embodiments of the present disclosure;

FIG. 26 is a diagram of a variation of a twelfth ranking hand composition in accordance with certain embodiments of the present disclosure;

FIG. 27 is a diagram of the structure of network game system in accordance with certain embodiments of the present disclosure;

FIG. 28 is a detailed diagram of the game client structure in accordance with certain embodiments of the present disclosure;

FIG. 29 is a diagram of an alternative structure of the game system in accordance with certain embodiments of the present disclosure; and

FIG. 30 is a diagram illustrating an isometric view of the game system in accordance with certain embodiments of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

As mentioned above, a typical Hwatu deck consists of 48 cards with 12 different categories wherein each category represents a calendar month. In certain embodiments of the present disclosure, the game can exclude at least eight cards. In at least one embodiment, the cards that are excluded can be four cards representing November (willow) and four cards representing December (paulownia). In addition, the game can exclude the two Junk cards from each month from January to October. Therefore, a deck used in certain embodiments of the game can include 20 cards in total having 20-point Gwang cards, 10-point Animal cards, and 5-point Ribbon cards. January, March, and August include 20-point Gwang cards; January and March include 5-point Ribbon cards; August includes 10-point Animal cards; February, April, July, and September include 10-point Animal cards and 5-point Ribbon cards only.

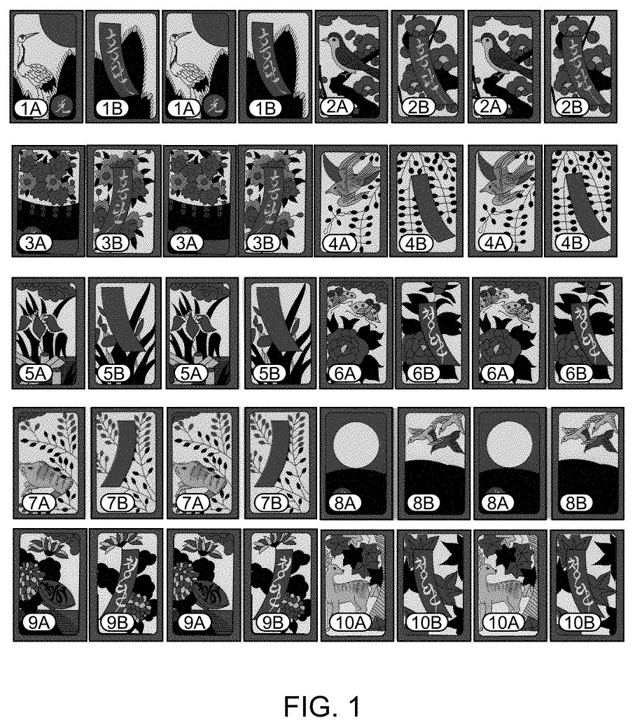

As shown in FIG. 1, two decks (totaling 40 cards) can be used to play the game. Card points and the meaning of each month can be displayed on the cards. This forty card arrangement is referred to as a double deck. A single deck is only 20 cards. In at least one embodiment, the meaning of each month can be labeled at the bottom-left corner of the cards with numbers ranging from 1 to 10 or roman numerals ranging from I to X. The card points can be depicted at the bottom-right corner of the cards. The top, bottom, left, and right of the cards are referenced when the card is upright and facing the player. In at least one embodiment, as illustrated in FIG. 1, both 20-point Gwang cards of January, March, and August and 10-point Animal cards of February, April, May, June, July, September, and October can be labeled with ‘A’ and a 10-point Animal card of August and 5-point Ribbon cards of January, February, March, April, May, June, July, September, and October can be labeled with ‘B’. In other embodiments, the meanings can be numbered at the bottom-left of the cards with, for example, ‘K’ representing 20-points, ‘S’ representing 10-points, and ‘O’ representing 5 points. In yet other embodiments, the cards can be labeled in any suitable manner to depict the meaning of each card.

In at least one embodiment, both meanings and points can be located together (next to each other) at the bottom-left or bottom-right corners with the combination of numbers and letters. For example, the meanings and points can be labeled together at the far left bottom corners and 20-points can be labeled with ‘K’, 10-points can be labeled with ‘S’, and 5-points can be labeled with ‘O’, respectively. For example, a 20-point pine Gwang card can be ‘1K’, a 5-point pine Ribbon (tti) card can be ‘1O’, a 10-point iris Animal (dongmul) card can be ‘5S’, and a 5-point iris Ribbon (tti) card can be ‘5O’. Alternatively, the meanings and points can be labeled together at the bottom-left corners, and 20-point Gwang cards of January, March, and August and 10-point Animal cards of February, April, May, June, July, September, and October can be labeled with ‘A’. A 10-point Animal card of August and 5-point Ribbon cards of January, February, March, April, May, June, July, September, and October can be labeled with ‘B’. For example, a 20-point pine Gwang card can be ‘1A’, a 5-point pine Ribbon (tti) card can be ‘1B’, a 10-point iris Animal (dongmul) card can be ‘5A’, and a 5-point iris Ribbon (tti) card can be ‘5B’.

As mentioned above, the meanings of months and the card points can be displayed on the cards. Although not shown in drawings, the meanings and points also can be labeled on the cards with different patterns of numbers and letters at the top/bottom/right/left corners so that even a player who is not familiar with Hwatu can recognize them easily. Further, the illustrations on the cards are not limited to the illustrated examples. The cards are not limited to months, Gwang, animals, and ribbons. As such, any suitable corresponding method of depicting different categories and levels of cards is applicable.

Referring to FIG. 1, the modified deck can contain 40 cards with points which can represent January to October, and the meanings of months can be labeled with numbers and the points can be labeled with letters. 20-point Gwang cards of January, March, and August and 10-point Animal cards of February, April, May, June, July, September, and October can be labeled as ‘A’ and a 10-point Animal card of August and 5-point Ribbon cards of January, February, March, April, May, June, July, September, and October can be labeled as ‘B’. However, a player may be able to recognize all the meanings and points without those numbers and letters on the cards for a game play. Therefore, the meaning and the points are based on but not limited to FIG. 1 for purposes of the following explanation.

In at least one embodiment of the game, cards distributed to individual players and cards commonly held by all players (“community cards”) can be combined to build a combination. Such combinations can be called ‘Ranks (Jokbo)’. In the game, a player can bet only during his or her turn, and other players must at least match the betting amount to stay in the game. If not, the other players must fold or leave the game. Each player can bet multiple times in a game.

In at least one embodiment, the basic action of a bet includes at least one of the following: bet (to place an allowed wager on a built combination to which others in the game must react), check (to pass a bet to another player if no one has yet opened the betting round), call (to match a bet or match a raise), half (to bet half of an existing bet in the same betting round), quarter (to bet ¼ of an existing bet in the same betting round), raise (to bet an additional bet on an existing bet in the same betting round), re-raise (to bet an additional bet on a raised bet in the same betting round), and fold (to forfeit the hand).

The game can be structured with three cards in a player's hand (cards distributed to an individual player) and three cards on a table. Therefore, with a total of 40 cards, the maximum number of players in a game is 12 [(three cards per player X 12 players)+three face-down community cards]. With a total of 60 cards (a triple deck), the maximum number of players in a game is 19 [(three cards per player X 19 players)+three face-down community cards].

Any number of players can play the game. As such, one, two, three, or more than three players can play the game.

In at least one embodiment, the Rank (Jokbo) to determine a winning hand in a game using a double deck can be defined as below. High-combination, low-combination, and special-combination can be determined by the combination of cards in each player's hand and face-up community cards. One of the three face-down community cards can be revealed as each betting round begins. In at least one embodiment, cards can be revealed by being oriented face-up. In other embodiments, the cards can be revealed in any way that the face of the card is shown. Each player can then pick three random cards which are not community cards and hold those cards in his/her hand. At the beginning, three community cards are face-down and one is flipped over (face-up) at each betting round. While all three community cards are face-down, the players go through the first round of betting. Additional bets can be made whenever a face-down community card is flipped over to be face-up. Therefore, there can be a total of four betting rounds. In at least one embodiment, there are no limits on the number or timing of betting that can be made. In other embodiments, limits can be placed on the number or timing of betting that can be made. After all community cards have been placed in the face-up position and all betting is finished, the ranks of each respective hand is established to determine the winning hand or hands as described below.

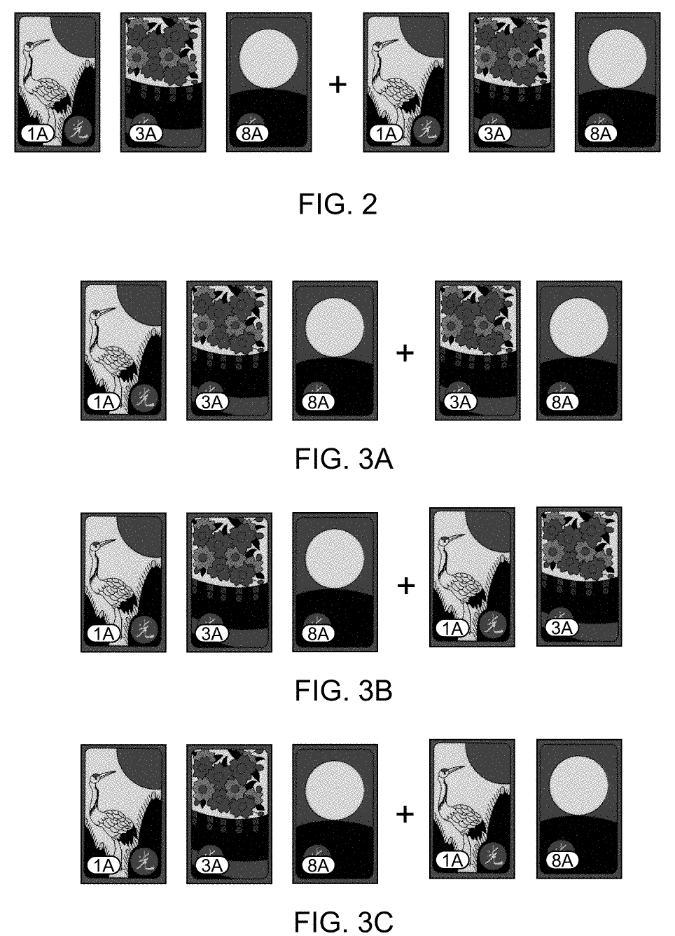

FIGS. 2-26 illustrate examples of different Ranks in order of hands, with Rank 1 being the strongest. The illustrated variations are only examples of each Rank, and are not dispositive of all possible variations of each Rank.

FIG. 2 illustrates a variation of a first rank (Rank 1), which can be achieved by possessing all six Gwang cards. For example: two ‘1A’ cards, two ‘3A’ cards, and two ‘8A’ cards. (1A, 3A, 8A+1A, 3A, 8A).

FIGS. 3A-3C illustrate variations of a second rank (Rank 2), which can be achieved by possessing five Gwang cards. Within the five Gwang cards, the rank must include three different Gwang cards. For example, ‘1A, 3A and 8A’ plus ‘3A and 8A’ [(1A, 3A, 8A)+(3A, 8A)] as illustrated in FIG. 3A, ‘1A, 3A, and 8A’ plus ‘1A and 3A’ [(1A, 3A, 8A)+(1A, 3A)] as illustrated in FIG. 3B, or ‘1A, 3A, and 8A’ plus ‘1A and 8A’ [(1A, 3A, 8A)+(1A, 8A)] as illustrated in FIG. 3C.

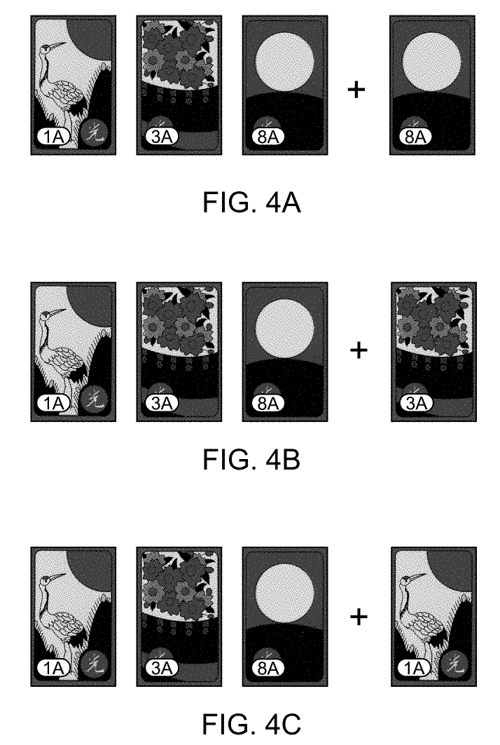

FIGS. 4A-4C illustrate variations of a third rank (Rank 3), which can be achieved by possessing four Gwang cards. Within the four Gwang cards, the rank must include three different Gwang cards. For example, ‘1A, 3A, and 8A’ plus ‘8A’, as illustrated in FIG. 4A, ‘1A, 3A, and 8A’ plus ‘3A’, as illustrated in FIG. 4B, or ‘1A, 3A, and 8A’ plus ‘1A’, as illustrated in FIG. 4C. ‘8A’ can have the highest order and ‘1A’ the least. As such, [{(1A, 3A, 8A)+(8A)}>{(1A, 3A, 8A)+(3A)}>{(1A, 3A, 8A)+(1A)}].

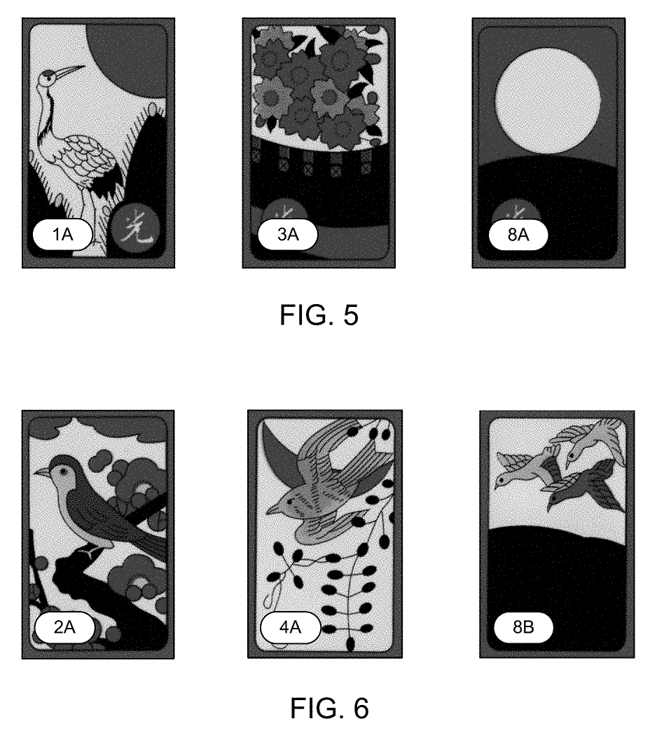

FIG. 5 illustrates a variation of a fourth rank (Rank 4), which can be achieved by possessing three Gwang cards. The three Gwang cards must all be different. For example: ‘1A, 3A, and 8A’ (also known as ‘138 Gwang-ddeng’).

FIG. 6 illustrates a variation of a fifth rank (Rank 5), which can be called special combination 1, consisting of three animal cards, ‘2A, 4A, and 8B’ (also known as ‘Godori’).

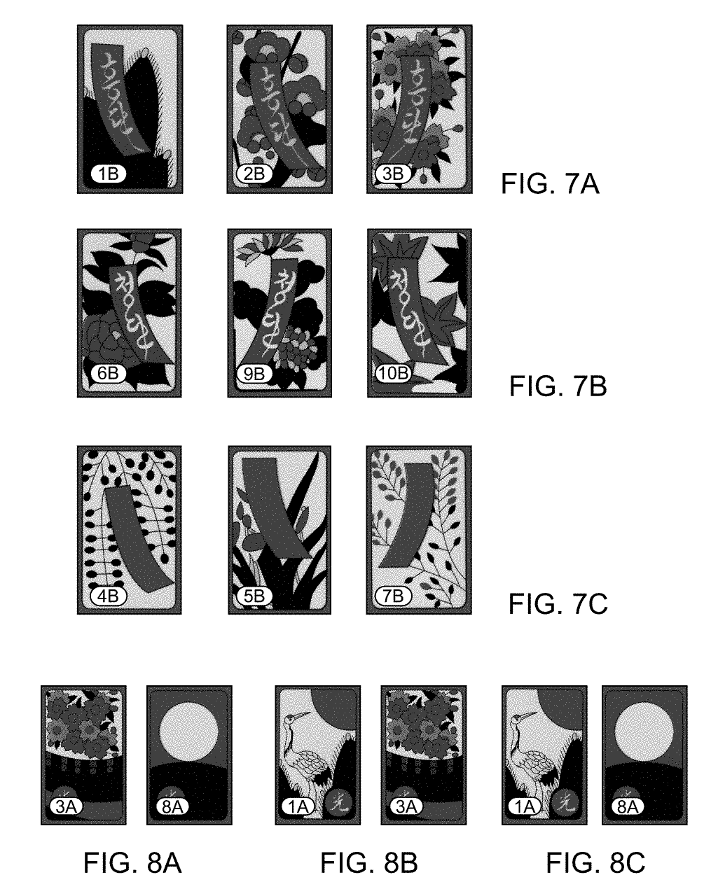

FIGS. 7A-7C illustrate variations of a sixth rank (Rank 6), which can be called special combination 2, consisting of three ribbon cards. The three combinations of Rank 6 can be ‘1B, 2B, and 3B’ (Hong-dan) as illustrated in FIG. 7A, ‘6B, 9B, and 10B’ (Chung-dan) as illustrated in FIG. 7B, or ‘4B, 5B, and 7B’ (Cho-dan) as illustrated in FIG. 7C. All three combinations can have the same order.

FIGS. 8A-8C illustrate variations of a seventh rank (Rank 7), which can be achieved by possessing two Gwang cards that are not the same. An example of Rank 7 can be ‘3A and 8A’ (also known as ‘38 Gwang-ddeng’) as illustrated in FIG. 8A. Alternatively, ‘1A and 3A’ (also known as ‘13 Gwang-ddeng’) as illustrated in FIG. 8B, or ‘1A and 8A’ (also known as ‘18 Gwang-ddeng’) as illustrated in FIG. 8C can be combinations of Rank 7. ‘3A and 8A’ can have the highest order, and ‘1A and 3A’ and ‘1A and 8A’ have the same order. As such, {(3A, 8A)>(1A, 3A)=(1A, 8A)}.

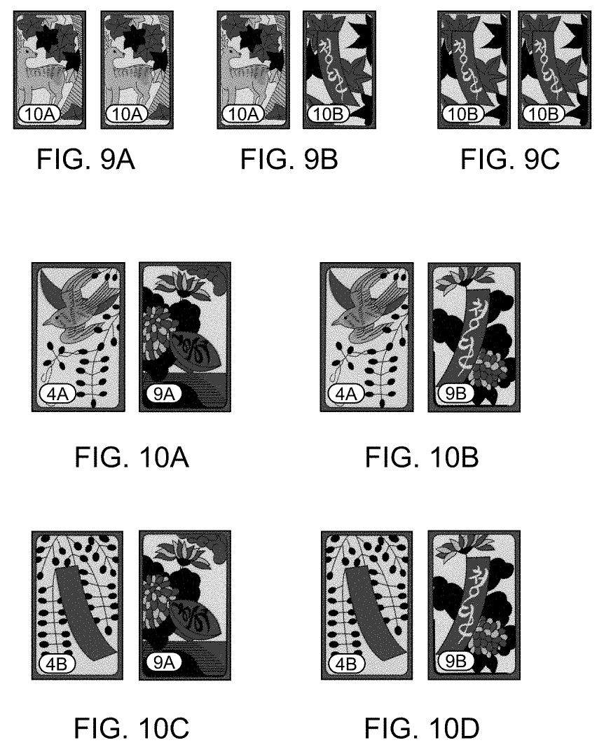

FIGS. 9A-9C illustrate variations of an eighth rank (Rank 8) which can be achieved by possessing two of four October cards (also known as ‘fang-ddeng’). For example, examples of Rank 8 can be ‘10A, 10A’ as illustrated in FIG. 9A, ‘10A, 10B’ as illustrated in FIG. 9B, or ‘10B, 10B’ as illustrated in FIG. 9C.

FIGS. 10A-10D illustrate variations of a ninth rank (Rank 9) which can be combinations of one April card and one September card. For example, Rank 9 can be one from either of ‘4A’ or ‘4B’ plus the other from either of ‘9A’ or ‘9B’ (also known as ‘Goosa’). A player holding Rank 9 cards can tie with every other player holding ranks 10 and below. If so, there is a rematch among players after a draw. If every other player folds or leaves the game, a player who has ‘Goosa’ wins the round. However, Rank 1 to 8 beat ‘Goosa’. A player holding cards between Rank 1 and 8 beats a player holding ‘Goosa’, but a player holding cards equal or below ‘9 ddeng’ must play a rematch against a player holding ‘Goosa’. If a player builds ‘Goosa’ and other ranks, the player can choose only one rank. For instance, if Player A can build ‘Goosa’ and ‘4 ddeng’ at the same time, Player A can choose ‘4 ddeng’ if Player A assumes that he or she can beat player B (holding ‘3 ddeng’). If not, Player A can choose ‘Goosa’. Players compete with their rank-builds in a game, and the ranks affect the game result.

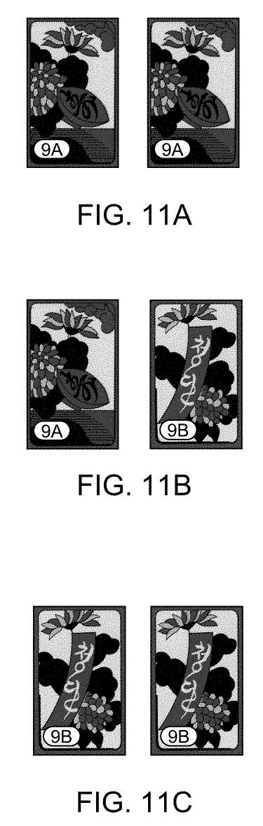

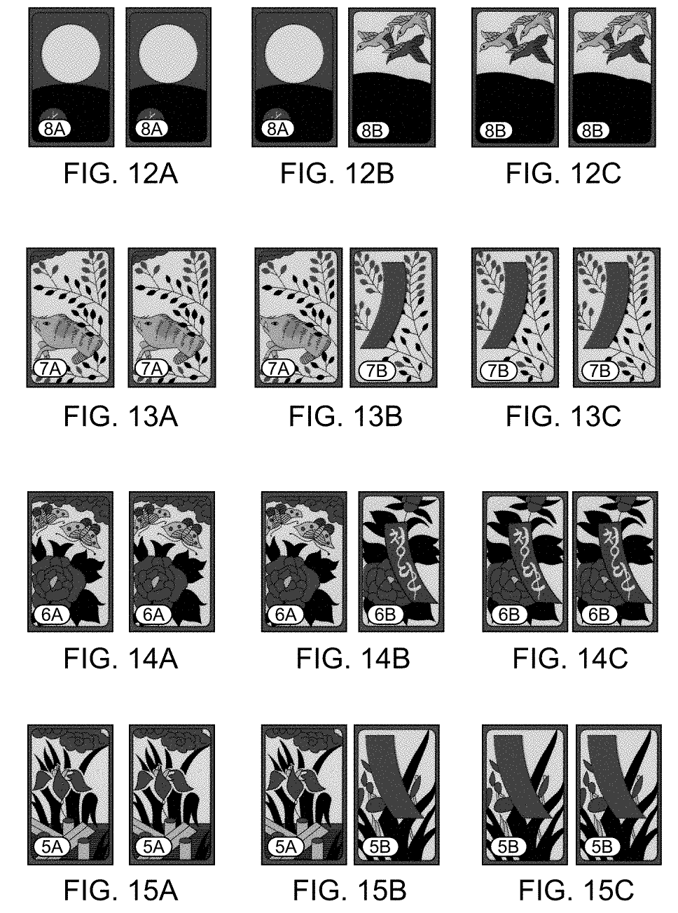

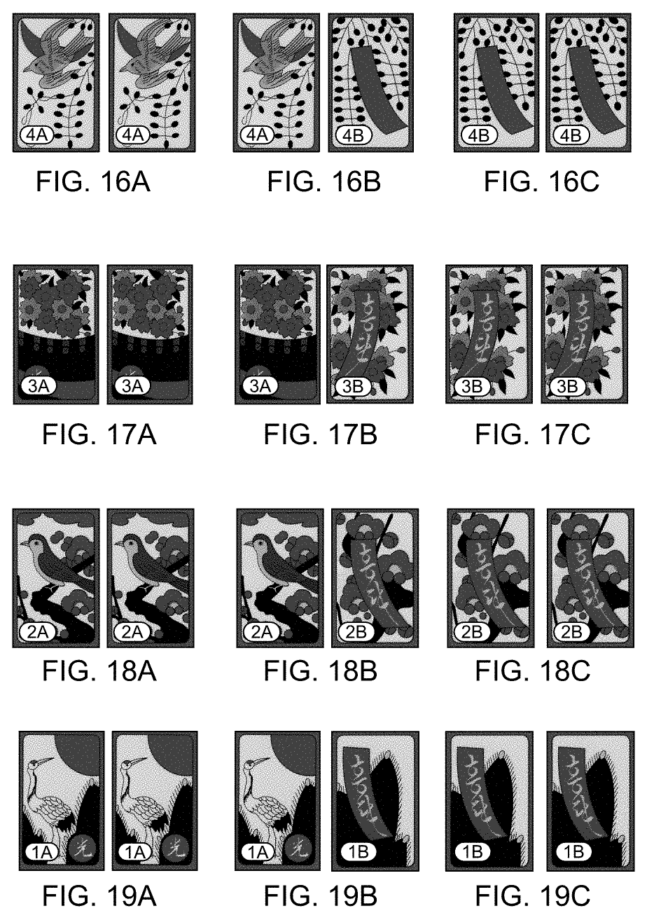

FIGS. 11A-19C illustrate variations of a tenth rank (Rank 10), which can be achieved by possessing two cards representing the same month (also known as ‘ddeng’). For example, ‘9A and 9A’, ‘9B and 9B’, or ‘9A and 9B’ is ‘9 ddeng’ as illustrated in FIGS. 11A-11C; ‘2A and 2A’, ‘2B and 2B’, or ‘2A and 2B’ is ‘2 ddeng’ as illustrated in FIGS. 18A-18C; and ‘1A and 1A’, ‘1B and 1B’, or ‘1A and 1B’ is ‘1 ddeng’ (also known as ‘bbung ddeng’) as illustrated in FIGS. 19A-19C. 8 ddeng is illustrated in FIGS. 12A-12C; 7 ddeng is illustrated in FIGS. 13A-13C; 6 ddeng is illustrated in FIGS. 14A-14C; 5 ddeng is illustrated in FIGS. 15A-15C; 4 ddeng is illustrated in FIGS. 16A-16C; and 3 ddeng is illustrated in FIGS. 17A-17C. The order of hands in ‘ddeng’ can descend from 9 ddeng to 1 ddeng. As such, 9 ddeng>8 ddeng>7 ddeng>6 ddeng>5 ddeng>4 ddeng>3 ddeng>2 ddeng>1 ddeng.

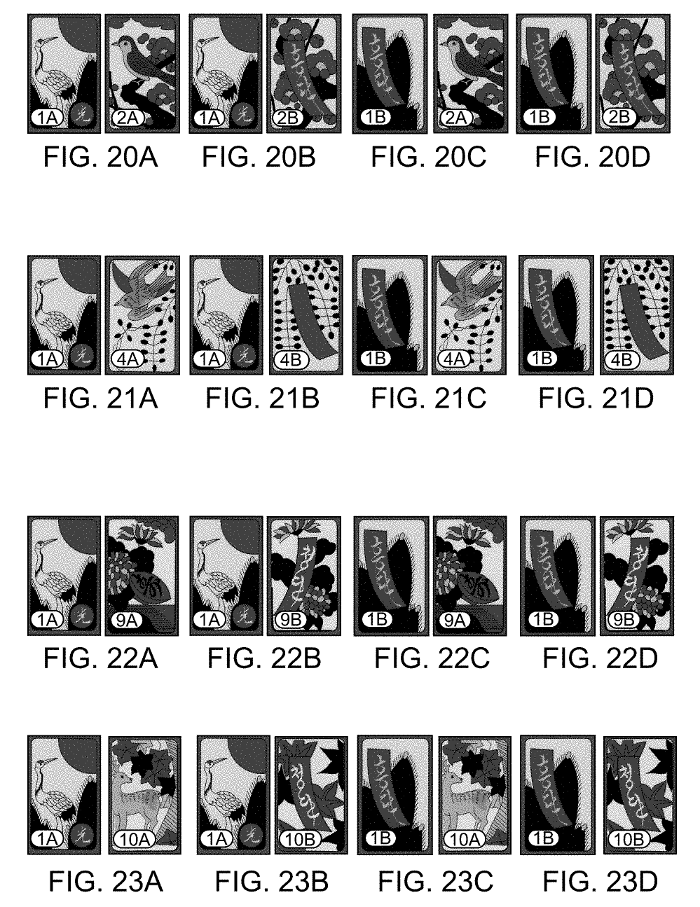

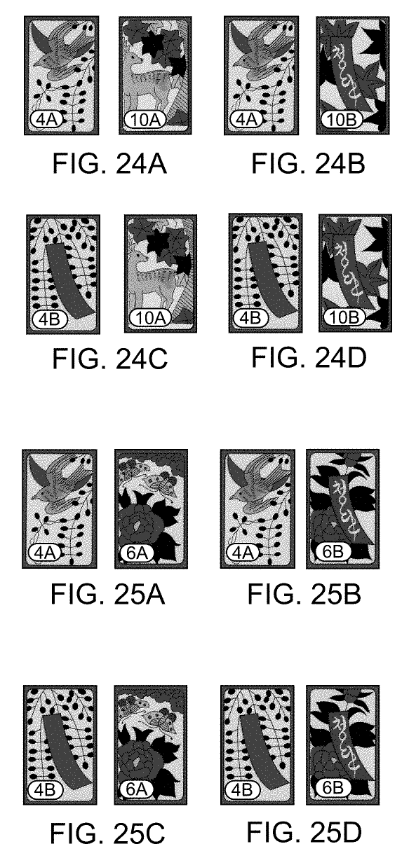

FIGS. 20A-25D illustrate variations of an eleventh rank (Rank 11), which can be achieved by possessing two cards representing different months. For example: holding either from ‘1A’ or ‘1B’ and either from ‘2A’ or ‘2B’ (also known as ‘Ali’) as illustrated in FIGS. 20A-20D, holding either from ‘1A’ or ‘1B’ and either from ‘4A’ or ‘4B’ (also known as ‘Doksa’) as illustrated in FIGS. 21A-21D, holding either from ‘1A’ or ‘1B’ and either from ‘9A’ or ‘9B’ (also known as ‘Goobbing’) as illustrated in FIGS. 22A-22D, holding either from ‘1A’ or ‘1B’ and either from ‘10A’ or ‘10B’ (also known as ‘Jangbbing’) as illustrated in FIGS. 23A-23D, holding either from ‘4A’ or ‘4B’ and either from ‘10A’ or ‘10B’ (also known as ‘langsa’) as illustrated in FIGS. 24A-24D, and holding either from ‘4A’ or ‘4B’ and either from ‘6A’ or ‘6B’ (also known as ‘Seryuk’) as illustrated in FIGS. 25A-25D. The order of hands for Rank 11 can be the following: Ali>Doksa>Goobbing>Jangbbing>Jangsa>Seryuk.

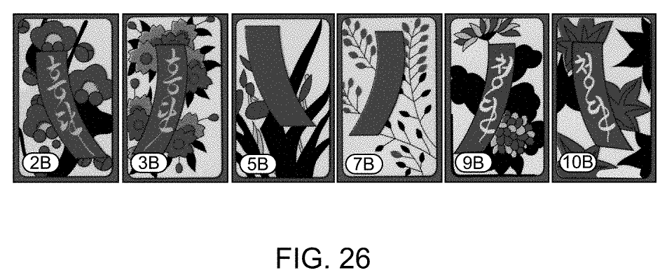

FIG. 26 illustrates a variation of a twelfth rank (Rank 12), which has no specific combination. If none of the above Ranks can be made with cards in a player's hand and face-up community cards by adding all the numbers on the cards in the player's hand and the community cards and taking the unit digit. The higher the number, the stronger the hand. For example, when the cards in the player's hand and on the table are ‘2B, 3B, 5B, 7B, 9B, and 10B’ as illustrated in FIG. 26, the sum is 36 and the unit digit is 6, which means ‘6 ggut’. ‘Ggut’ orders as follow: 9 (also known as ‘gab-o’)>8>7>6>5>4>3>2>1>0 (also known as ‘Mangtong’).

A game can end in a draw by at least the following: 1) between players holding cards resulting in the same rank, 2) between players building ‘Goosa’ and other players building rank between 10 and 12, or 3) between players building ranks that are weaker than the rank of faced-up community cards. Once a game ends in a draw, players can play a rematch. In at least one embodiment, players who folded or left the game can rejoin the rematch by paying game money, for example, half of the entire pot. Another example of money paid by players who wish to rejoin the game can be, for example, double the entire pot. Different types of betting amounts can apply. In the rematch, the game rules can be the same as a normal game. In at least one embodiment, each player randomly picks two cards, and the game ends at the first betting round based on the ranks described above.

Upon an agreement among players, Gwang ddeng can require additional ddeng price from a player(s), who did not fold until the end of the game, in addition to the pot. An example of ddeng price can be, for example, 1) three times the initial pot when possessing two of four October cards (rank 8: Jang ddeng), 2) four times the initial pot when possessing two Gwang cards (rank 7: 38 Gwang ddeng), 3) five times the initial pot when possessing special combination 2 (rank 6: Hong-dan, Chung-dan, or Cho-dan), 4) seven times the initial pot when possessing special combination 1 (rank 5: Godori), 5) ten times the initial pot when possessing three Gwang cards (rank 4: 138 Gwang ddeng), 6) fifteen times the initial pot when possessing four Gwang cards (rank 3: 138 Gwang-ddeng+(8A or 3A or 1A), 7) twenty times the initial pot when possessing all five Gwang cards (rank 2: 138 Gwang-ddeng+(1A and 3A or 1A and 8A or 3A and 8A), or 8) thirty times the initial pot when possessing all six Gwang cards (Rank 1). Both ddeng price and rate can be decided by agreement among players.

As described above, in at least one embodiment of the game, each player is dealt three cards and three community cards are dealt face-down. After a first round of betting based on the three cards in each player's hand, one of the face-down community cards is flipped over to be face-up and a second round of betting occurs wherein each remaining player (for example. all players who did not fold or leave the game) bets based on their hand comprising the three individual cards and the one face-up community card. After the second round of betting, another face-down community card is flipped over to be face-up and a third round of betting occurs wherein each remaining player bets based on their hand comprising the three individual cards and the two face-up community cards. After the third round of betting, the final face-down community card is flipped over to be face-up and a final round of betting occurs wherein each remaining player bets based on their hand comprising the three individual cards and the three face-up community cards. After all community cards have been placed in the face-up position and all betting is finished, the ranks of each respective remaining player hand is established to determine the winning hand or hands by the ranks as described above. In at least one embodiment there is no limit to the amount of times that a player or players can raise or re-raise in any single round of betting. In alternative embodiments, a player or players can only raise or re-raise up to three times in any single round of betting, and alternatively only two times in any single round of betting. In alternative embodiments, an initial bet (“ante”) is required to be dealt the three individual cards in addition to the betting rounds.

In an alternative embodiment of the game each player is dealt five cards. After the players receive the cards an initial betting round occurs. After the initial round of betting is finished, each remaining player can optionally discard any number of cards in their hand and exchange them for the equivalent number on cards from the deck. After each player has elected or declined to discard and exchange cards, a final round of betting occurs. After all betting is finished, the rank of each respective remaining player 5-card hand is established to determine the winning hand or hands by the ranks as described above. In at least one embodiment there is no limit to the amount of times that a player or players can raise or re-raise in any single round of betting. In alternative embodiments, a player or players can only raise or re-raise up to three times in any single round of betting, and alternatively only two times in any single round of betting. In alternative embodiments, an ante is required to be dealt the five individual cards in addition to the betting rounds. In alternative embodiments of the game each player is dealt six cards and after all betting is finished, the rank of each respective remaining player 6-card hand is established to determine the winning hand or hands by the ranks as described above.

In another alternative embodiment of the game, players are dealt six cards, two at a time with a round of betting between each set of two cards. In this alternative embodiment, each player is dealt a first set of two cards and a first round of betting occurs. After the first round of betting is finished, every remaining player is dealt a second set of two cards and a second round of betting occurs. After the second round of betting is finished, every remaining player is dealt a third set of two cards and a final round of betting occurs. After all betting is finished, the rank of each respective remaining player 6-card hand is established to determine the winning hand or hands by the ranks as described above. In at least one embodiment there is no limit to the amount of times that a player or players can raise or re-raise in any single round of betting. In alternative embodiments, a player or players can only raise or re-raise up to three times in any single round of betting, and alternatively only two times in any single round of betting. In alternative embodiments, an ante is required to be dealt the first set of two cards in addition to the betting rounds. In alternative embodiments, after the third set of two cards has been dealt and the corresponding round of betting occurs, a first community card can be dealt face-up and another round of betting occurs wherein each player's hand consists of the six cards selected from the six cards dealt to the player and the community card. In alternative embodiments, the first community card is only dealt at the majority vote of players. In alternative embodiments, each player can option to use the first community card by paying an ante prior to the dealing of the first community card. In alternative embodiments, a second community card can be dealt face-up and another round of betting occurs wherein each player's hand consists of the six cards selected from the six cards dealt to the player and the first and second community cards. In alternative embodiments, the second community card is only dealt at the majority vote of players. In alternative embodiments, each player can option to use the second community card by paying an ante prior to the dealing of the second community card.

In another alternative embodiment of the game, each player is dealt five cards wherein the cards are dealt one at a time with a round of betting between the dealing of each card. In this alternative embodiment a first card is dealt to every player face-down such that only the individual can see the face-down card. After dealing the first card, a first round of betting occurs. After the first round of betting is finished, every remaining player is dealt a second card such that the card is face-up for every other player as well as the individual player to see but the face-up card can only be used by the individual player to whom it was dealt. A second round of betting then occurs. After the second round of betting is finished, every remaining player is dealt a third card face-down and a third round of betting occurs. After the third round of betting is finished, every remaining player is dealt a fourth card face-up and a fourth round of betting occurs. After the fourth round of betting is finished, every remaining player is dealt a fifth card face-down and a fifth round of betting occurs.

After the fifth round of betting is completed, the rank of each respective remaining player 5-card hand is established to determine the winning hand or hands by the ranks as described above. In alternative embodiment, after the fifth round of betting is completed, a single community card can be dealt face-up and another round of betting occurs wherein each player's hand consists of cards selected from the five cards dealt to the player and the community card. In alternative embodiments, the single community card is only dealt at the majority vote of players. In alternative embodiments, each player can option use the single community card by paying an ante prior to the dealing of the single community card. In another alternative embodiment, after the fifth round of betting is completed, every remaining player is dealt a sixth card face-up and a sixth round of betting occurs. After the sixth round of betting is completed, the rank of each respective remaining player 6-card hand is established to determine the winning hand or hands by the ranks as described above. In yet another alternative embodiment, after the six round of betting is completed, every remaining player is dealt a seventh card face-down and a seventh round of betting occurs. After the seventh round of betting is completed, the rank of each respective remaining player 6-card hand is established to determine the winning hand or hands by the ranks as described above. In at least one embodiment there is no limit to the amount of times that a player or players can raise or re-raise in any single round of betting. In alternative embodiments, a player or players can only raise or re-raise up to three times in any single round of betting, and alternatively only two times in any single round of betting. In alternative embodiments, an ante is required to be dealt the first set of two cards in addition to the betting rounds.

In the present disclosure, the bulk of the description focuses on examples involving the first embodiment of the game described above, but the disclosure is not limited to such.

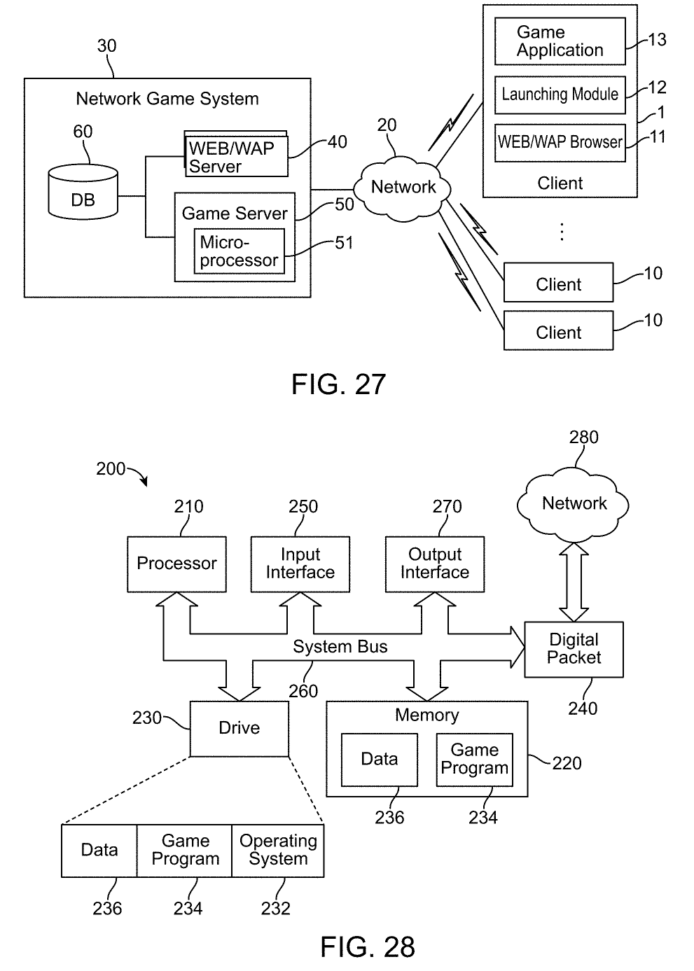

In certain embodiments of the present disclosure, the game can be played on a digital platform. FIG. 27 is a diagram of a structure of network game system in accordance with an exemplary embodiment and FIG. 28 is a detailed diagram of a game client structure in accordance with an exemplary embodiment.

As illustrated in FIG. 27, the network game system 30 can include a wireless Ethernet bridge (“WEB”) or a wireless application protocol (“WAP”) server 40, a game server 50, and a database (“DB”) 60.

One or more clients 10 are connected by the WEB/WAP server 40, the game server 50, and a game network 20. The network 20 can include every wireless network, including wired networks such as an internet and dial-up connection, wireless internet mobile networks, and satellite networks.

The network game system 30 can enable a game player to play the game online with at least one other player through the game network 20 and maximize commercial marketing effects by introducing various advertisements and content during the game. In the game server 50, the network game system 30 can provide player-versus-player or player-versus-computer games like the game via the game network 20, including a wire/wireless internet connection, etc. Also, the network game system 30 can store content and advertisements from content providers and advertisers in the DB 60 and provide them through the network 20 on the WEB/WAP 40 server.

The network 20 can connect the network game system 30 and the one or more clients 10 to set up data inter-communication.

The DB 60 can store game player statistics such as, for example, rankings, wins/defeats, betting information, etc. in real time in addition to multimedia content and advertisements. Details for the game statistic information will be discussed below.

Types of advertisements can be a simple advertisement delivering only information without special rewards for game players. If advertisements are for PC players or mobile phone/tablet players, the aforementioned advertisements can include, but are not limited to, 1) mileage advertisements to enhance participation of members in advertisements by giving product discounts depending on corresponding mileage points; 2) event advertisements that allow members to click pop-ups and to participate in events such as quizzes to win a prize; and 3) instant-purchase advertisements that allow members to request product information or order products by watching advertisements.

The field of advertisement can be product or service categories of advertisers similar to categorical divisions as seen in, for example, typical shopping malls. Examples can include, but are not limited to, clothing, furniture, healthcare products, foods, flowers, agricultural and fisheries products, office products, adult products, toys, movies, music, beverages/liquors, vehicles, accessories, daily supplies, electronics, electric appliances, and computers.

Advertisers can directly determine the types and fields of advertisements and send those to the WEB/WAP server 40, or advertisers can send content only to the WEB/WAP server 40 and the WEB/WAP server 40 can analyze the content and save the content into the DB 60 according to advertisement types and categories.

Each client 10 can establish a communication environment by including a WEB/WAP browser, which allows a connection to the network 20 and can have the same structure as FIG. 28. Specifically, each client 10 can include a WEB/WAP browser 11, launching module 12, and game application 13, as a player device for game play via the network 20. The client 10 can be a portable communication device, a mobile communication device, a mobile computer, a smartphone, a computing pad, a tablet computer, a personal computer, a desktop computer, a laptop computer, a netbook, a set-top phone, a portable digital assistant (PDA), or other electronic device capable of at least accepting data, transmitting data, and executing commands The client 10 can include a touch-sensitive display and a processor coupled to the touch-sensitive display. In at least one embodiment, the touch-sensitive display can include a capacitance-sensitive display, a pressure-sensitive display, or a resistive-sensitive display. In other embodiments, the touch-sensitive display can be any display that is configured to interact with a finger, stylus, pointing device, or other selection “gesture” that is either in contact or near contact with the display. Client types are not limited, as long as the network game service is available via a wired/wireless network connection.

The WEB/WAP browser 11 can receive WEB/WAP pages, which allows the WEB/WAP browser 11 to ask for player login or game play from the WEB/WAP server 40 operated by a game service provider, and shows the player login or game play on a display (not shown) of the client 10. If players decide to play a game via the WEB/WAP pages, the WEB/WAP browser 11 runs the launching module 12. Then the launching module 12 launches the game application 13 and connects the game application 13 to the game server 50.

The launching module 12 can be automatically downloaded to the client 10 by an objecting tag on WEB/WAP pages provided by the WEB/WAP server 40. It can be installed in multiple formats, including but not limited to, an ActiveX control format. When an player sends a request to play a game via WEB/WAP pages, the launching module 12 runs the game application 13 as previously mentioned and also updates the game application 13 to the latest version.

The game application 13 can be a program or an application installed on the client 10 and allows a player to play a game. When a player tries to enter a channel or game room, the game application 13 receives information about the channel and game room from the game server 50. During a game, the game application 13 can also send and receive game packets for game playing. It is not necessary, however, to install the game application 13 on the client 10, and game service can be provided through the WEB/WAP browser 11 without installing a separate application.

Referring to FIG. 28, the composition of a client 200 can include a processor 210, memory 220, and one or more drives 230.

The processor 210 can control a series of processes for game service. The processor 210 can be a multipurpose, programmable device that accepts digital data as input, processes the data according to instructions stored in its memory, and provides results as output. The processor 210 can be configured to execute instructions stored on a non-transitory medium. The processor 210 can include any general purpose processor and a hardware module or software module stored in a storage device, configured to control the processor 210 as well as a special-purpose processor where software instructions are incorporated into the actual processor design. The processor 210 may essentially be a completely self-contained computing system, containing multiple cores or processors, a bus, memory controller, cache, etc. A multi-core processor may be symmetric or asymmetric.

The drive 230 can be used to save data for computer interpretable commands, a data structure, a program module, content, and the clients 200. Also, the drive 230 can include an operating system 232, game program 234, and/or data 236. The drive 230 can include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Memory 220 can include read-only memory (ROM) for storing software performing the operations discussed below. The memory 220 can also include random access memory (RAM) for storing results. The memory 220 can save the game program 234 and data 236 sent by other components of the drive 230 or the client 200.

The client 200 can include an input interface 250 through which commands and data are inputted. An input device can be connected to the input interface 250. For example, an input device can be an electronic digitizer, a microphone, a pointing device such as a keyboard or a mouse, a trackball or a touch pad. The client 200 can be a portable communication device, a mobile communication device, a mobile computer, a smartphone, a computing pad, a tablet computer, a personal computer, a desktop computer, a laptop computer, a netbook, a set-top phone, a portable digital assistant (PDA), or other electronic devices capable of at least accepting data, transmitting data, and executing commands The client 200 can include a touch-sensitive display and a processor coupled to the touch-sensitive display. In at least one embodiment, the touch-sensitive display can include a capacitance-sensitive display, a pressure-sensitive display, or a resistive-sensitive display. In other embodiments, the touch-sensitive display can be any display that is configured to interact with a finger, stylus, pointing device, or other selection “gesture” that is either in contact or near contact with the display. Alternatively, the input device can be a joystick, a game pad, a satellite dish scanner, or any other suitable device.

The above-mentioned input devices or other input devices can be connected to the processor 210 via the input interface 250 linked to a system bus 260. These input devices can be connected by a parallel port, a game port, a USB, or other such interface. The client 200 can include other output devices such as a speaker, a video display, or any other output device that can be connected through an output interface 270.

The client 200 can communicate with one or more other clients within the network 280 through a digital packet 240. Other clients can be a personal computer, a server, a router, a network PC, a mobile phone, a peer device, or other forms of network nodes, and include components, partially or fully, which have been described above in relation to the client 200. The network 280 can be a wired or a wireless network, a broadband network, other types of Ad-hoc networks, or combination thereof. The network 280 can be any means to couple a client 200 to a server. The network 280 can be hardwired, wireless, or a combination thereof. In at least one embodiment, the network 280 can be the Internet. The clients 200 can connect to the network 280 through LAN, WAN, WIFI, short range wireless, or BLUETOOTH. In at least one embodiment, the client 200 can be connected to the network 280, and the processor 210 can run the game program 234.

In FIG. 27, when players log in, the WEB/WAP server 40 of the network game system 30 authorizes corresponding players and sends WEB/WAP pages which connect the players' requests for game playing to the client 10.

A game starts upon a player creating a game room or a game invitation, a microprocessor 51 of the game server 50 transmits game packets between players in the game. Additionally, the microprocessor 51 can provide game statistics and information about statistics of winning the game for each betting round.

The microprocessor 51 of the game server 50 can send information of game waiting room displays to the client 10. A player that wants to play a game over a network 20 can select an empty spot in a multi-player game (2 players, 3 players, 4 players, 5 players, 6 players, etc.). Each player can be his or her own client 10 to play a game connected to the game server 50. The microprocessor 51 can set up a game between players and, during the game in four-player mode, for instance, provides player A game statistics (rankings, wins/defeats, betting information, etc.) to the other three players B, C, and D. It can also provide each player the real time chance-to-win probability information in the game.

In at least one embodiment, game statistics of at least one other player can be provided to each player. For example, player A can receive information about players B, C, and D. The information might not be available for a player (e.g. player B) who folds or leaves the game but is available to the remaining players (e.g. player A, C, and D) who continue playing. The game statistics are constantly provided to each player who logs on to the client 10 and joins a game. Information of every game result (wins/defeats, betting, etc.) is updated on the real time basis.

The game statistics can include information on rankings, wins/defeats, betting, etc. Game ranking can increase as a player plays games. For example, four points are awarded for a win, two points for a draw, and a single point for a defeat. Thus, the ranking can increase even if a player loses a game. Also, the ranking is subdivided into ranking class 1, which excludes a rematch after a draw, and ranking class 2, which involves a rematch after a draw. Ranking classes 1 and 2 can be either displayed separately or combined together. It is more efficient to display betting information with game records. For example, if four bets are made in a game and if player C leaves or folds the game in the third betting, “1 defeat, betting 3” information is recorded in the DB 60 in real time. The ranking and betting information for each player is recorded in real time, and player A can see the game statistics for player C in a different game. Before starting a game, for instance, player A can review the game statistics of player C including ranking, entire game records (wins/defeats), and betting information (for example, Betting 1: 00 wins/00 defeats, Betting 2: 00 wins/00 defeats, Betting 3: 00 wins/00 defeats, Betting 4: 00 wins/00 defeats). Player A can review the game statistics of player D as well while in the game with player C.

Game statistics can be updated every betting round. For example, in a current third betting round, the game records of players (player C: 00 wins/00 defeats, player D: 00 wins/00 defeats), excluding any player who folded a game (player B) in the third betting round can be provided to player A. Likewise, the game records of players A and D at the third betting round can be reviewed by player C, and the game records of players A and C at the third betting round can be reviewed by player D. The game statistics available at each betting round can help players predict the patterns of the other players for more strategic betting in a game.

In game statistics, a chance to build Ranks (Jokbo), in a game can be estimated on a real time basis and can be provided to each player. For example, the chance of player A to build ranks on each betting stage in a game can be calculated and provided to player A, and a chance of player C to build ranks on each betting round in a game can be calculated and provided to player C. Information about each player's chance to win a game is provided at each betting round, as described below.

The procedure of game play can be run by the microprocessor 51 at the game server 50 and can be run by the partial function of the game program. Game play and ranks are discussed above. The information about game records (wins/defeats) will be described below.

The microprocessor 51 of the game server 50 can run the game according to the procedure, and cards are distributed according to the type of multi-player game.

For example, in 4-player game mode, Players A, B, C, and D can be each given three cards in their hands (not shown to each other) and three community cards can be provided face-down as described in the first embodiment of the game above. The microprocessor 51 opens and displays each player's cards to the corresponding player. For example, Player A can see only his or her cards, and the others player cards are displayed as face-down. Then, a first round of betting occurs. After the first round of betting is finished, one of the three face-down community cards is flipped over and displayed as face-up. All the remaining players then continue to the second betting round. If Player B folds at the second betting round, the microprocessor 51 flips one of the two remaining community face-down cards over to become face-up. Players A, C, and D continue on to the third betting round, where the final face-down community card is turned face-up and the players bet. Any player can fold in any betting round. In betting round four, players compete against each other based on the ranks. The player with the highest ranking had wins the game. Alternatively, if after the completion of any round of betting only one player remains (that is, has not folded or left the game) that player wins the game.

The microprocessor 51 can provide each player information about his or her chance or probability that he or she can build a rank in every betting round. The information can be provided in real time. All of the cards held by all players and face-up community cards can be considered to calculate the chance or probability. In other words, face-down community cards are not considered in the calculation.

For example, assume the first embodiment of the game describe above is being played, and player A has ‘3A, 8A, and 1B’, player B has ‘3A, 4A, and 1B’, player C has ‘4A, 5B, and 10B’, and player D has ‘7A, 8B, and 9A’, and ‘1A, 8A, and 6A’ cards are on the table. As mentioned above, the game statistics considers the cards in the players' hands and the face-up community cards. For example, player A's chance to build ranks is calculated as follows.

In the first betting round, player A's probability can be calculated and displayed while all the community cards are face-down.

For example, player A (holding 3A, 8A, and 1B) has 0% to build Rank 1 (six Gwang cards) [(1A, 3A, 8A) (1A, 3A, 8A)] because player B already holds 3A.

Also, the odds are 0% for player A to build [(1A, 3A, 8A) (1A, 3A)] and [(1A, 3A, 8A) (3A, 8A)] of Rank 2 (five Gwang cards) because player B already holds 3A.

The odds are 0.03% {(2C2X1C1/28C3)×100%} for player A to build [(1A, 3A, 8A) (1A, 8A)]. This is determined by dividing the number of cases to pick 3 cards of 1A, 1A, and 8A (or 2C2X1C1) by number of cases to pick 3 community cards from 28 cards (40 cards less 12 cards distributed to the players) (or 28C3). The number of cases to pick two 1As is 2C2 (there are two 1As left including face-down community cards), and the number of cases to pick one 8A is 1C1 (there is one 8A left including faced-down cards on the table).

The odds are 1.59% {(2C1X1C1X26C1/28C3)×100%} to build Rank 3 [(1A, 3A, 8A) 8A]. This is determined by dividing the number of cases to pick 2 cards of 1A and 8A in 3 selected cards (or 2C1X1C1X26C1) by number of cases to pick 3 community cards from 28 cards (40 cards less 12 cards distributed to the players) (or 28C3). The number of cases to pick one 1A is 2C1 (there are two 1As left including faced-down community cards), and the number of cases to pick one 8A is 1C1 (there is one 8A left including face-down community cards). As the last card can be picked from the remaining 26 cards, it is 26C1.

The odds are 0% to build Rank 3 [(1A, 3A, 8A) 3A] because player B already holds 3A.

The odds are 0.79% {(2C2X26C1/28C3)×100%} to build Rank 3 [(1A, 3A, 8A) 1A]. This is determined by dividing the number of cases to pick 2 cards of 1A and 8A in 3 selected cards (or 2C2X26C1) by number of cases to pick 3 community cards from 28 cards (40 cards less 12 cards distributed to the players) (or 28C3). The number of cases to pick two 1As is 2C2 (there are two 1As left including face-down community cards). As the last card can be picked from the remaining 26 cards, it is 26C1.

The odds are 21.42% {(2C1X27C2/28C3)×100%} to build Rank 4 [(1A, 3A, 8A) 1A]. This is determined by dividing the number of cases to pick one 1A in 3 selected cards (or 2C1X27C2) by number of cases to pick 3 community cards from 28 cards (40 cards less 12 cards distributed to the players) (or 28C3). The number of cases to pick one 1A is 2C1 (there are two 1As left including face-down community cards). As the last two cards can be picked from the rest of 27 cards, it is 27C2.

The odds are 0% to build Rank 5 (Godori) [(2A, 4A, 8B)] because players B and C already hold 4As.

The odds are 0% to build Rank 6 (Hong-dan) [(2A, 4A, 8B)] because players B and C already hold all of 1B cards.

The odds are 0.12% {(2C1X2C1X1C1/28C3)×100%} to build Rank 6 (Chung-dan) [(6B, 9B, 10B)]. This is determined by dividing the number of cases to pick 6B, 9B, 10B in 3 selected cards (or 2C1X2C1X1C1) by the number of cases to pick 3 community cards from 28 cards (40 cards less 12 cards distributed to the players) (or 28C3). The number of cases to pick one 6B is 2C1 (there are two 6Bs left including face-down community cards), the number of cases to pick one 9B is 2C1 (there is one 9B left including face-down community cards), and the number of cases to pick one 10B is 1C1 (there is one 10B left including face-down community cards).

The odds are 0.12% {(2C1X1C1X2C1/28C3)×100%} to build Rank 6 (Cho-dan) [(4B, 5B, 7B)]. This is determined by dividing the number of cases to pick 4B, 5B, 7B in 3 selected cards (or 2C1X1C1X2C1) by the number of cases to pick 3 community cards from 28 cards (40 cards less 12 cards distributed to the players) (or 28C3). The number of cases to pick one 4B is 2C1 (there are two 4Bs left including face-down community cards), the number of cases to pick one 5B is 1C1 (there is one 5B left including face-down community cards), and the number of cases to pick one 7B is 2C1 (there is one 7B left including face-down community cards).

The odds are 100% to build Rank 7 (38 Gwang-ddeng) [(3A, 8B)] because player A holds the cards.

The above probabilities or percentages are rounded to the third decimal place, but they can be rounded up or rounded down in the decimal place.

Similarly, the probabilities to build other ranks on the first betting round can be calculated and provided to player A. players B, C, and D also can review their own probabilities in the same betting round. As previously mentioned, players can see the result of the calculation but not the actual calculations.

If all four players bet in round 1, one of the face-down community cards (e.g., assume ‘1A’ from ‘1A, 8A, 6A’) on the table is flipped over and displayed as a face-up card.

Then all the players can proceed to the second betting round, and they can review the rank probabilities. As one more of the three cards is flipped over in subsequent betting rounds, the rank probabilities change and can be displayed accordingly.

At betting round 2, as two community cards are still face-down, player A's probabilities to build ranks are based on the following.

If a rank has 0% probability in the first betting round, it remains as 0% in rounds 2, 3, and 4. Below describes probabilities to build other ranks.

The odds are 0.28% {(1C1X1C1/27C2)×100%} to build Rank 2 (five Gwangs) [(1A, 3A, 8A) (1A, 8A)]. This is determined by dividing the number of cases to pick 1A and 8A in 2 selected cards (or 1C1X1C1) by the number of cases to pick 2 community cards from 27 cards (40 cards less 12 cards distributed to the players and 1 face-up community card) (or 27C2). The number of cases to pick one 1A is 1C1 (there is one 1A left including face-down community cards) and the number of cases to pick one 8A is 1C1 (there is one 8A left including face-down community cards).

The odds are 7.40% {(1C1X26C1/27C2)×100%} to build Rank 3 (four Gwangs) [(1A, 3A, 8A) 8A)]. This is determined by dividing the number of cases to pick 8A in 2 selected cards (or 1C1X26C1) by the number of cases to pick 2 community cards from 27 cards (40 cards less 12 cards distributed to the players and 1 face-up community card) (or 27C2). The number of cases to pick one 8A is 1C1 (there is one 8A left including face-down community cards). As the last card can be picked from the rest of 26 cards, it is 26C1.

The odds are 7.40% {(1C1X26C1/27C2)×100%} to build Rank 3 (four Gwangs) [(1A, 3A, 8A) 1A)]. This is determined by dividing the number of cases to pick 1A in 2 selected cards (or 1C1X26C1) by the number of cases to pick 2 community cards from 27 cards (40 cards less 12 cards distributed to the players and 1 face-up community card) (or 27C2). The number of cases to pick one 1A is 1C1 (there is one 1A left including face-down community cards). As the last card can be picked from the rest of 26 cards, it is 26C1.

The odds are 100% to build Rank 4 (three Gwangs) [(1A, 3A, 8A)] because player A already holds ‘3A, 8A’, and ‘1A’ is a face-up community card.

The odds are 0% to build Rank 6 (Chung-dan) [(6B, 9B, 10B)] because player A does not have cards to build Chung-dan and also the first face-up community card is not one of Chung-dan cards. It is 0% to build Rank 6 (Cho-dan) [(4B, 5B, 7B)] because player A does not have cards to build Cho-dan and also the first face-up community card is not one of Cho-dan cards.

Similarly, probabilities to build other ranks on the second betting round can be calculated and can be provided to player A. Players B, C, and D also can review their own probabilities in the same betting round.

Similarly, probabilities to build ranks on the third and fourth betting rounds are calculated and provided to each player.

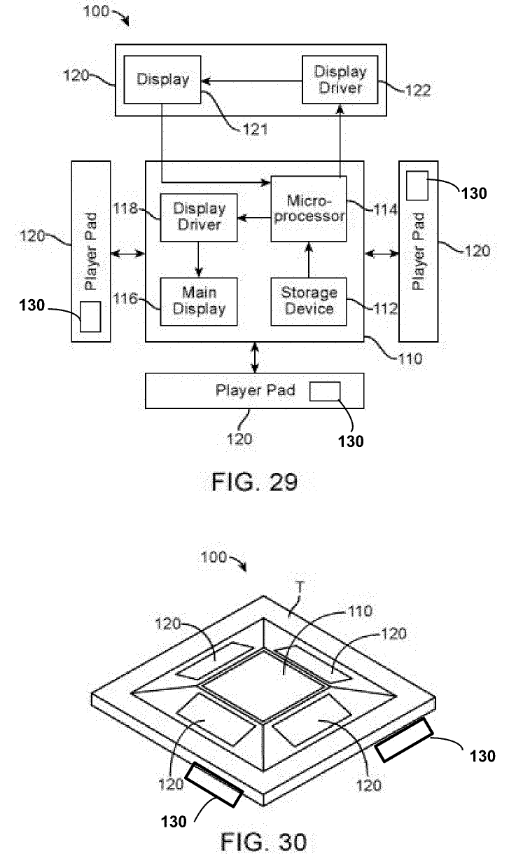

As shown in FIG. 29, in at least one embodiment, a body 110 and a player pad 120 can be utilized in a game system 100. The body 110 and player pad 120 can be utilized with or without a network. The body 110 can include storage device 112, a microprocessor 114 at the storage device 112 reading the game program, a main display 116 visualizing game contents, and a display driver 118 controlled by the microprocessor 114 to run the main display 116. The microprocessor 114 can read programs stored in the storage device 112, and, based on the output, the microprocessor 114 can control the display driver 118 to display game status or rounds on the main display 116. The microprocessor 114 and the storage device 112 can function in a similar way as the microprocessor 51 and the DB 60 shown in FIG. 27.

The microprocessor 114 can transmit game packets between players in the game and provide game statistics and information about a chance to win the game per each betting round. Additionally, the main display 116 can display advertisements.

On each player pad 120, the microprocessor 114 can display three cards randomly picked from total 40 cards for each player. For example, the microprocessor can display ‘3A, 8A, 1B’ on player A's pad, ‘3A, 4A, 1B’ on player B's pad, ‘4A, 5B, 10B’ on player C's pad, and ‘7A, 8B, 9A’ on player D's pad. The players can be allowed to see the three cards on their own screen only. Although all the cards distributed to each player can be displayed in the main display 116, the cards are not shown to the other players.

The microprocessor 114 can also display the three face-down community cards. For example, the microprocessor can display ‘1A, 8A, 6A’ face-down on the main display 116.

Players A, B, C, and D can enter the first betting round. If all the players are in round 1, the microprocessor 114 can flip over one of the three face-down community cards and display the flipped card on the main display 116. Players A, B, C, and D can now enter the second betting round. In round 2, assume Player B folds or left the game. The microprocessor 114 opens one of the two faced-down community cards and displays it on the main display 116. Now there are two face-up community cards and player A, C, and D enter the third betting round. A player(s) can fold or leave the game in any betting round. In the final betting round, remaining players compete to each other based on their ranks. The player with the highest ranking had wins the game. Alternatively, if after the completion of any round of betting only one player remains (that is, has not folded or left the game) that player wins the game.

The microprocessor 114 can provide a player with game statistics (rankings, wins/defeats, betting records, etc.) of other players on his or her player pad 120. For example, the microprocessor 114 can provide the game statistics (player rankings, wins/defeats, betting records, etc.) to each player. For example, if the current betting round is 3, Player A can review game statistics of players C and D but not of player B who folded or left the game. Likewise, players C and D can review the game statistics of players A and D and players A and C, respectively. The information can be provided each betting round. The game statistics can be updated periodically by the microprocessor 114 but can be provided on a real time basis upon player request.

The microprocessor 114 can provide each player real time information about the probability that a player has to build ranks in each betting round and display the information on the pads 120. The game probability can be updated at predetermined times by the microprocessor 114 but can also be provided in real time basis upon player request.

As an LCD (Liquid Crystal Display) touch device, the main display 116 can function as both input and output devices. The main display 116 can display game information as the microprocessor 114 reads the game programs and also display a graphic interface that can be manipulated by touching the screen.

The player pad 120 can be connected electrically to the body 110 and can display game status and round information related to players using the player pads 120 by running the game program stored in the body 110. The player pads 120 can be installed for each player, displaying the player's game records (wins/defeats) and including a display showing the player's action 121 and a display driver 122 controlled by the microprocessor 114 to run the display 121. Depending on the game play, the player pads 120 can include a menu that displays player action buttons. The menu can be placed either on the player pad 120, the display 121, or the main display 116 on the body 110 as a touch pad. The display 121 installed for a player shall be placed against the other players' display 121 on the pads 120 so that any displayed information may not be exposed.

The player pad 120 can also include a currency acceptor 130. The currency acceptor 130 is communicatively coupled with the microprocessor 114. The currency acceptor 130 can accept paper currency, electronic currency, tickets, magnetic cards, or any other suitable currency or credit. While the term currency is used throughout this disclosure, the disclosure is not limited to money currency and can be any form of credit to allow the user to participate in the game. With paper currency, the currency acceptor 130 may use one or more drive belts connected to a drive motor to pull the paper currency into and through the currency acceptor 130. A sensor can read the printing on the face of the currency. For example, a light sensitive sensor can be used which includes a light source and a receiver that detects the reflection or transmission of the light.

In other examples, the currency acceptor 130 can also include a magnetic card reader. The currency acceptor 130 can also include a laser scanner or camera to capture codes, such as QR codes. In yet other examples, the currency acceptor 130 can also include a radio frequency system. In further examples, the currency acceptor 130 may accept a form of identification, such as a magnetic card or a radio frequency signal, which signals the identification of a player. As such, the amount of currency associated with that player may be displayed and/or the player may then choose the amount of currency to play with from the available funds. Any suitable method, device, or system to accept currency can be utilized with the currency acceptor 130.

In at least one example, the currency acceptor 130 can also include a printer or currency disposal. For example, if a player wins or wants to cash out, the currency acceptor 130 may print out a ticket for the player to redeem at a redemption center or provide currency directly to the player.

When the currency acceptor 130 validates and confirms the currency, the player can then play the game. The amount of currency is then input into the game and the player can place bets based on the amount of currency that was input. If the player runs out of funds, then the player may be prompted to input more currency or may quit the game.

FIG. 29 illustrates four player pads 120 but this is for example only. More or less than four player pads 120 can be installed. For instance, it can be a pentagonal shape for five players, a hexagonal shape for six players, or other various shapes.

The game, however, is not limited to the hardware structure that includes the body 110 and the player pad 120 described above. The function of the body 110 and the player pad 120 also can be realized by software, firmware, or various software and firmware combinations. Alternatively, the function of the body 110 and the player pad 120 can be realized by various computing devices such as a personal computer, tablet computer, mobile device, etc. An exemplary external structure of the game system 100 including the body 110 and the player pad 120 is described below.

FIG. 30 is a diagram illustrating an isometric view of the game system in accordance with an exemplary embodiment.

As shown in FIG. 30, the game system 100 includes the body 110 at the center of a game table T and 4 player pads 120 installed at each edge of the game table T. A rectangular game table T is illustrated in FIG. 30, but its shape can be round, triangular, pentagonal, hexagonal, octagonal, or any other shape. The shape can be based on the number of players.

As shown in FIG. 30, the game pads 120 and the body 110 can be a single unit with a flat or angled surface to face players. The player pads 120 can have LCD touchscreens and can function as both input and output devices. As the microprocessor 114 runs the game program, the player pads 120 can display game information and content for game playing and also display the graphic interface that can be manipulated by players with a touch motion.

However, the structure of the body 110 and the player pad 120 is not limited to the above. For example, LED, OLED, or other display technologies can be used instead of LCD for the displays of the body 110 and the player pad 120. In addition to the touch screen, pens, keypads, etc. can be used as input methods or devices. The game table T can be made of various materials including plastic, metal, metal alloy, wood, etc.

Although it is not shown in drawings, if the game table T is viewed from the side, the top, which includes the game system 100, can be supported by structures. The height of the supporting structures can be determined by the average sitting height of adults.

The dimensions of each component (top, supporting structure, etc.) of the game table T can vary based on the physical conditions of players or other requirements.

A game method run by the above microprocessor is explained with examples in accordance with an exemplary embodiment. The aforementioned game method can be realized as a readable computer code on one or more storage devices. The one or more storage devices can include constitute any data storage device readable by a computer system, such as a ROM, RAM, CD-ROM, magnetic tape, floppy disk, SSD, etc. The game method can also be realized by a carrier wave (e.g., internet transfer). The computer-readable storage devices can deviate the game method to the computer system connected by the network to save and run the code. Programmers in related fields can program functional programs, codes, and code segments to realize the above examples.

Although versions have been described in relation to a number of other versions of the present disclosure, it should be understood that numerous other modifications and embodiments can be devised by those skilled in the art that will fall within the spirit and scope of the principles of this disclosure. More particularly, numerous variations and modifications are possible in the components parts and/or arrangements of the subject combination arrangement within the scope of the disclosure, the drawings, and the appended claims. In addition to variations and modifications in the components parts and/or arrangements, alternative uses will also be apparent to those skilled in the art.

What is claimed is:

1. A gaming system including:
a player input system;
at least one processor coupled to the player input system;
one or more display devices, each coupled to the at least one processor;
a currency acceptor coupled to the at least one processor;
at least one memory device coupled to the at least one processor and storing instructions executable by the at least one processor to:
receive, from the currency acceptor, a form of currency;
display an individual hand of three cards from a deck of cards to each of one or more players of the gaming system, wherein a deck of cards comprising one or more sets of twenty cards, one of the one or more sets of twenty cards consisting of three Gwang cards, nine ribbon cards, and eight animal cards, wherein one of the one or more sets of twenty cards consisting of:
a first category consisting of one Gwang card and one ribbon card;
a second category consisting of one animal card and one ribbon card;
a third category consisting of one Gwang card and one ribbon card;
a fourth category consisting of one animal card and one ribbon card;
a fifth category consisting of one animal card and one ribbon card;
a sixth category consisting of one animal card and one ribbon card;
a seventh category consisting of one animal card and one ribbon card;
an eighth category consisting of one Gwang card and one animal card;
a ninth category consisting of one animal card and one ribbon card; and
a tenth category consisting of one animal card and one ribbon card;
providing a hand of three cards to each of at least a first player and a second player;
providing the at least the first player and the second player three community cards face down from the deck of cards;
receiving a first bet from one of the first player and the second player;
flipping over a first card of each of the three face-down cards;
receiving a second bet from one of the first player and the second player;
flipping over a second card of each of the three face-down cards;
receiving a third bet from one of the first player and the second player;
flipping over a third card of each of the three face-down cards;
determining a winning hand based on a rank of the three cards in the hand provided to the first player and the second player and the three community cards,
wherein the rank is determined as follows:
a first rank comprising three Gwang cards, wherein the three Gwang cards are from different categories;
a second rank comprising three animal cards;
a third rank comprising three ribbon cards;
a fourth rank comprising two Gwang cards, wherein the two Gwang cards are different;
a sixth rank comprising two cards from the tenth category;
a seventh rank comprising one card from the fourth category and one card from the ninth category;
an eighth rank comprising two cards of the same category, wherein the categories are from the first category to the ninth category;
a ninth rank comprising two cards from two different categories; and
a tenth rank, wherein the first rank to the ninth rank are not provided;
wherein the first rank wins over the second rank, the second rank wins over the third rank, the third rank wins over the fourth rank, the fourth rank wins over the fifth rank, the fifth rank wins over the sixth rank, the sixth rank wins over the seventh rank, the seventh rank wins over the eighth rank, the eighth rank wins over the ninth rank, and the ninth rank wins over the tenth rank.

2. The method as recited in claim 1, wherein, when the deck includes two or more sets of the twenty cards, and providing for three pre-rank combinations as follows:
a first pre-rank comprising six Gwang cards;
a second pre-rank comprising five Gwang cards, wherein three of the Gwang cards are from different categories;
a third pre-rank comprising four Gwang card, wherein three of the Gwang cards are from different categories;
wherein the first pre-rank wins over the second pre-rank, the second pre-rank wins over the third pre-rank, and the third pre-rank wins over the first rank.

3. The method as recited in claim 2,
wherein the third pre-rank further comprises:
a first level comprising one Gwang card from each of the first category and the third category, and two Gwang cards from the eighth category;
a second level comprising one Gwang card from each of the first category and the eighth category, and two Gwang cards from the third category;
a third level comprising one Gwang card from each of the third category and the eighth category, and two Gwang cards from the first category;
wherein the first level wins over the second level, and the second level wins over the third level.
wherein the third rank further comprises:
a first level comprising one ribbon card from each of the first category, the second category, and the third category;
a second level comprising one ribbon card from each of the sixth category, the ninth category, and the tenth category; and
a third level comprising one ribbon card from each of the fourth category, the fifth category, and the seventh category;
wherein the first level does not win over the second level, the second level does not win over the third level, and the third level does not win over the first level.

4. The gaming system as recited in claim 1, further comprising a database that is configured to store game statistics,
wherein the gaming statistics are displayed to the one or more players prior to receiving the first bet, the second bet and the third bet, and
wherein the gaming statistics are updated prior to receiving each of the of first bet, the second bet, and the third bet, based upon the cards that are displayed to the one or more players which includes the hand of three cards as well as revealed community cards.

5. The gaming system as recited in claim 1, wherein instead of receiving one of the first bet, the second bet, or the third bet, receiving instructions to fold,
wherein when every player but one of the one or more players fold, the one player remains and wins.

6. The gaming system as recited in claim 1,
wherein the seventh rank further comprises:
a first level comprising two cards from the first category;
a second level comprising two cards from the second category;
a third level comprising two cards from the third category;
a fourth level comprising two cards from the fourth category;
a fifth level comprising two cards from the fifth category;
a sixth level comprising two cards from the sixth category;
a seventh level comprising two cards from the seventh category;
an eighth level comprising two cards from the eighth category; and
a ninth level comprising two cards from the ninth category;
the first level wins over the second level, the second level wins over the third level, the third level wins over the fourth level, the fourth level wins over the fifth level, the fifth level wins over the sixth level, the sixth level wins over the seventh level, the seventh level wins over the eighth level, and the eighth level wins over the ninth level;
wherein the eight rank further comprises:
a first level comprising one card from the first category and one card from the second category;
a second level comprising one card from the first category and one card from the fourth category;
a third level comprising one card from the first category and one card from the ninth category;
a fourth level comprising one card from the first category and one card from the tenth category;
a fifth level comprising one card from the fourth category and one card from the tenth category; and
a sixth level comprising one card from the fourth category and one card from the sixth category;
the first level wins over the second level, the second level wins over the third level, the third level wins over the fourth level, the fourth level wins over the fifth level, and the fifth level wins over the sixth level.

7. The gaming system as recited in claim 1, wherein the three animal cards of the second rank are from the second category, the fourth category, and the eighth category.

8. The gaming system as recited in claim 1, wherein the two Gwang cards of the fourth rank are one Gwang card from the third category and one Gwang card from the eighth category.

9. A method for playing a card game comprising:
provide a gaming system including:
a player input system;
at least one processor coupled to the player input system;
one or more display devices, each coupled to the at least one processor;
a currency acceptor coupled to the at least one processor;
at least one memory device coupled to the at least one processor and storing instructions executable by the at least one processor;
receive, by the currency acceptor, a form of currency;
providing, by the gaming system, a deck of cards comprising two or more sets of twenty cards, two sets of the twenty cards consisting of six Gwang cards, eighteen ribbon cards, and sixteen animal cards, wherein the two sets of twenty cards consisting of:
a first category consisting of two Gwang cards and two ribbon cards;
a second category consisting of two animal cards and two ribbon cards;
a third category consisting of two Gwang cards and two ribbon cards;
a fourth category consisting of two animal cards and two ribbon cards;
a fifth category consisting of two animal cards and two ribbon cards;
a sixth category consisting of two animal cards and two ribbon cards;
a seventh category consisting of two animal cards and two ribbon cards;
an eighth category consisting of two Gwang cards and two animal cards;
a ninth category consisting of two animal cards and two ribbon cards; and
a tenth category consisting of two animal cards and two ribbon cards;
providing, from the gaming system, a hand of three cards to each of at least a first player and a second player;
providing, from the gaming system, the at least the first player and the second player three community cards face down from the deck of cards;
receiving, by the gaming system, a first bet from one of the first player and the second player;
flipping, by the gaming system, over a first card of each of the three face-down cards;
receiving, by the gaming system, a second bet from one of the first player and the second player;
flipping, by the gaming system, over a second card of each of the three face-down cards;
receiving, by the gaming system, a third bet from one of the first player and the second player;
flipping, by the gaming system, over a third card of each of the three face-down cards;
determining, by the gaming system, a winning hand based on a rank of the three cards in the hand provided to the first player and the second player and the three community cards,
wherein the rank is determined as follows:
a first rank comprising six Gwang cards;
a second rank comprising five Gwang cards, wherein three of the Gwang cards are from different categories;
a third rank comprising four Gwang card, wherein three of the Gwang cards are from different categories;
a fourth rank comprising three Gwang cards, wherein the three Gwang cards are from different categories;
a fifth rank comprising three animal cards;
a sixth rank comprising three ribbon cards;
a seventh rank comprising two Gwang cards, wherein the two Gwang cards are different;
an eighth rank comprising two cards from the tenth category;
a ninth rank comprising one card from the fourth category and one card from the ninth category;
a tenth rank comprising two cards of the same category, wherein the categories are from the first category to the ninth category;
an eleventh rank comprising two cards from two different categories; and
a twelfth rank, wherein the first rank to the eleventh rank are not provided;
wherein the first rank wins over the second rank, the second rank wins over the third rank, the third rank wins over the fourth rank, the fourth rank wins over the fifth rank, the fifth rank wins over the sixth rank, the sixth rank wins over the seventh rank, the seventh rank wins over the eighth rank, the eighth rank wins over the ninth rank, the ninth rank wins over the tenth rank, the tenth rank wins over the eleventh rank, and the eleventh rank wins over the twelfth rank.

10. The method as recited in claim 9, wherein instead of receiving one of the first bet, the second bet, or the third bet, receiving input from the at least one of the first player or the second player to fold.

11. The method as recited in claim 10, wherein when every player but one of the one or more players fold, the one player remains and wins.

12. The method as recited in claim 9, wherein the tenth rank further comprises:
a first level comprising two cards from the first category;
a second level comprising two cards from the second category;
a third level comprising two cards from the third category;
a fourth level comprising two cards from the fourth category;
a fifth level comprising two cards from the fifth category;
a sixth level comprising two cards from the sixth category;
a seventh level comprising two cards from the seventh category;
an eighth level comprising two cards from the eighth category; and
a ninth level comprising two cards from the ninth category;
wherein the first level wins over the second level, the second level wins over the third level, the third level wins over the fourth level, the fourth level wins over the fifth level, the fifth level wins over the sixth level, the sixth level wins over the seventh level, the seventh level wins over the eighth level, and the eighth level wins over the ninth level.

13. The method as recited in claim 9, wherein the three animal cards of the fifth rank are from the second category, the fourth category, and the eighth category.

14. The method as recited in claim 9, wherein the sixth rank further comprises:
a first level comprising one ribbon card from each of the first category, the second category, and the third category;
a second level comprising one ribbon card from each of the sixth category, the ninth category, and the tenth category; and
a third level comprising one ribbon card from each of the fourth category, the fifth category, and the seventh category;
wherein the first level does not win over the second level, the second level does not win over the third level, and the third level does not win over the first level.

15. The method as recited in claim 9, wherein the third rank further comprises:
a first level comprising one Gwang card from each of the first category and the third category, and two Gwang cards from the eighth category;
a second level comprising one Gwang card from each of the first category and the eighth category, and two Gwang cards from the third category;
a third level comprising one Gwang card from each of the third category and the eighth category, and two Gwang cards from the first category;
wherein the first level wins over the second level, and the second level wins over the third level.

16. The method as recited in claim 16, wherein the seventh rank further comprises:
a first level comprising two cards from the first category;
a second level comprising two cards from the second category;
a third level comprising two cards from the third category;
a fourth level comprising two cards from the fourth category;
a fifth level comprising two cards from the fifth category;
a sixth level comprising two cards from the sixth category;
a seventh level comprising two cards from the seventh category;
an eighth level comprising two cards from the eighth category; and
a ninth level comprising two cards from the ninth category;
wherein the first level wins over the second level, the second level wins over the third level, the third level wins over the fourth level, the fourth level wins over the fifth level, the fifth level wins over the sixth level, the sixth level wins over the seventh level, the seventh level wins over the eighth level, and the eighth level wins over the ninth level.

17. The method as recited in claim 16, wherein the three animal cards of the second rank are from the second category, the fourth category, and the eighth category.

18. The method as recited in claim 16, wherein, when the deck includes two or more sets of the twenty cards, and providing for three pre-rank combinations as follows:
a first pre-rank comprising six Gwang cards;
a second pre-rank comprising five Gwang cards, wherein three of the Gwang cards are from different categories;
a third pre-rank comprising four Gwang card, wherein three of the Gwang cards are from different categories;
wherein the first pre-rank wins over the second pre-rank, the second pre-rank wins over the third pre-rank, and the third pre-rank wins over the first rank.

19. The method as recited in claim 18,
wherein the third pre-rank further comprises:
a first level comprising one Gwang card from each of the first category and the third category, and two Gwang cards from the eighth category;
a second level comprising one Gwang card from each of the first category and the eighth category, and two Gwang cards from the third category;
a third level comprising one Gwang card from each of the third category and the eighth category, and two Gwang cards from the first category;
wherein the first level wins over the second level, and the second level wins over the third level.
wherein the third rank further comprises:
a first level comprising one ribbon card from each of the first category, the second category, and the third category;
a second level comprising one ribbon card from each of the sixth category, the ninth category, and the tenth category; and
a third level comprising one ribbon card from each of the fourth category, the fifth category, and the seventh category;
wherein the first level does not win over the second level, the second level does not win over the third level, and the third level does not win over the first level.
